(19) United States
(12) Patent Application Publication
(10) Pub. No.: US 2025/0188920 A1
(43) Pub. Date: Jun. 12, 2025

(54) POSITIVE DISPLACEMENT PUMP AND PUMP SYSTEM

(71) Applicant: NETZSCH-Gerätebau GmbH, Selb (DE)

(72) Inventors: Stefan Weigl, Mühldorf (DE); Thomas Schmitt, Lohkirchen (DE); Dominik Sinseder, Dorfen (DE); Torsten Remmler, Ammerbuch (DE); Levente Szántó, Hof (DE); Georg Krist, Marktredwitz (DE); Martin Brunner, Konradsreuth (DE); Lars-Peter Weiland, Schönwald (DE)

(21) Appl. No.: 18/966,198

(22) Filed: Dec. 3, 2024

(30) Foreign Application Priority Data
Dec. 12, 2023 (DE) 10 2023 134 814.0

(51) Int. Cl. F04B 51/00; F04B 49/00

(52) U.S. Cl. CPC F04B 51/00; F04B 49/00

(57) ABSTRACT

A positive displacement pump for conveying material to be conveyed is described, including a measuring assembly with at least one measuring channel, through which at least a portion of the material to be conveyed, which is conveyed by the pump, can flow, wherein the at least one measuring channel has a non-circular cross section and the measuring assembly has a pressure sensor assembly for detecting pressures, which act at positions, which are spaced apart in the flow-through direction of the at least one measuring channel, when the at least one portion of the material to be conveyed, which is conveyed by the pump, flows through the at least one measuring channel. A system with the positive displacement pump and a control unit is further described.

### TECHNICAL FILED

The present invention relates to a positive displacement pump and a pump system with such a positive displacement pump.

### BACKGROUND

Positive displacement pumps, such as, e.g., eccentric screw pumps, rotary piston pumps, screw spindle pumps or hose pumps serve the purpose of conveying material to be conveyed. The material to be conveyed is free-flowing material to be conveyed, in particular liquid or (e.g., low- or high-) viscous material to be conveyed. Examples of such materials to be conveyed comprise process liquids, such as cooling liquids, oils, varnishes and paints, which are used during the production of a workpiece. Waste water and sludge may be mentioned as further examples.

Even though common positive displacement pumps provide for a conveying of the material to be conveyed, they do not allow for an analysis thereof. In particular the viscosity of the material to be conveyed can be of interest in certain scenarios. In the case of known solutions, a sample of the material to be conveyed is taken during standstill of the positive displacement pump in order to analyze the material to be conveyed. The sample is subsequently analyzed in a laboratory, for example to determine the viscosity of the material to be conveyed. This approach is labor- and time-intensive.

### SUMMARY

In light of the foregoing, it is an object of the present invention to provide a positive displacement pump, which provides for an analysis of the material to be conveyed.

According to the invention, a positive displacement pump according to claim 1 and a pump system according to claim 10 is provided.

The positive displacement pump for conveying material to be conveyed comprises a measuring assembly with at least one measuring channel, through which at least a portion of the material to be conveyed, which is conveyed by the pump, can flow. The at least one portion of the material to be conveyed, which is conveyed by the pump, corresponds in particular to a portion of the volume flow of the material to be conveyed, which is conveyed by the pump. The at least one portion of the material to be conveyed, which is conveyed by the pump, can be referred to as volume flow proportion, volume proportion or quantity proportion.

The at least one measuring channel has a non-circular cross section. The cross section is a section through the at least one measuring channel orthogonally to the flow-through direction thereof. The cross section can (e.g., over a total length of the at least one measuring channel) be constant in the flow-through direction of the at least one measuring channel.

The measuring assembly has a pressure sensor assembly for detecting pressures, which act at positions, which are spaced apart in the flow-through direction of the at least one measuring channel, when the at least one portion of the material to be conveyed, which is conveyed by the pump, flows through the at least one measuring channel. These pressures can act outwards from an interior of the at least one measuring channel. The measuring assembly or/and the pressure sensor assembly can in particular determine pressure differences between two or more of the detected pressures.

A positive displacement pump of this type provides for the detection of pressures along the measuring channel with non-circular cross section. These pressures are different, depending on the material to be conveyed, and thus provide for a direct analysis of the material to be conveyed by means of the positive displacement pump. The non-circular cross section of the measuring channel has proven to be particularly advantageous hereby because it ensures a flow profile in the measuring channel, which is advantageous for the pressure measurements.

The cross section of the at least one measuring channel can comprise at least one straight section. In this case, the at least one measuring channel can comprise at least one flat side surface, which forms the at least one straight section of the cross section.

The at least one straight section can lead with one of its ends to a corner of the cross section or can lead with both of its ends to respective corners of the cross section. Such a corner can draw an angle, which lies between 10° and 170°, for example between 45° and 135°, in particular an angle of 90°.

In one example, the cross section is polygonal. The corners can hereby in each case be formed by two of the at least one straight section. The cross section can be a polygon, whereby each of the sides of the polygon corresponds to one of the at least one straight section.

The cross section can be rectangular. Each of the four sides of the rectangular cross section can correspond to one of the at least one straight section hereby.

The pressure sensor assembly is configured, for example, to detect a pressure, which acts from an interior of the at least one measuring channel onto a sensor surface (e.g., outwards). For this purpose, the pressure sensor assembly can have a pressure sensor, which detects the pressure acting on the sensor surface. A separate sensor surface and a separate pressure sensor can be provided for each pressure to be detected.

The sensor surface can form a section of the cross section of the measuring channel. The sensor surface can be formed to be essentially flat. The sensor surface in particular forms one of the at least one straight section of the cross section. The sensor surface can thus form a flat section of a side wall of the at least one measuring channel. In an alternative design, the sensor surface can be designed to be curved. It is possible in this case that the sensor surface forms a curved section of the cross section. The sensor surface can extend over a portion of the length of the at least one measuring channel in the flow-through direction thereof. Designs of this type of the sensor surface can reduce turbulences and flow deflections in the measuring channel, which provides for a more reliable pressure measurement.

According to one example, the cross section has a height, which is smaller than the width thereof. In this case, the sensor surface can run in the width direction of the cross section. The sensor surface can thus extend in particular over a total width of the measuring channel.

The measuring assembly can comprise a flow straightener, which is arranged upstream of the at least one measuring channel in a flow path of the material to be conveyed, which is conveyed by the pump. The flow straightener can be arranged directly in front of the at least one measuring channel, in particular connect thereto. The flow straightener can form an inlet opening, which tapers in the flow-through direction, of the at least one measuring channel. The inlet opening can be rounded, for example, so that it does not form a step to the measuring channel in the flow-through direction.

The at least one measuring channel or/and the flow straightener can be designed so that a laminar flow profile of the conveyed material to be conveyed is ensured in the measuring channel (e.g., in a specified conveying speed range of the positive displacement pump or/and for a predetermined viscosity range of the material to be conveyed), in particular in the width direction or/and in the height direction of the at least one measuring channel.

The at least one measuring channel can comprise several measuring channels, through which at least a portion of the material to be conveyed, which is conveyed by the pump, can flow in each case. These measuring channels differ in particular in their cross sections. The cross sections can differ in their surface area. The cross sections can be formed in the same geometric shape (e.g. rectangular), but can have different (e.g., scaled) dimensions of this geometric shape. It is thus conceivable that polygons of different sizes with the same side length ratio are provided as cross sections. The (e.g., rectangular) cross sections of the measuring channels can differ in particular in their height and can have the same width. The pressure sensor assembly is formed in particular for detecting the pressures in each of the measuring channels in this case.

The measuring channels of the measuring assembly are, for example, fluidically connected in parallel. In this case, the measuring channels also differ in the at least one portion of the material to be conveyed, which is conveyed by the pump, which can flow through the respective measuring channel. A different volume flow proportion of the material to be conveyed, which is conveyed by the pump, can thus be assigned to each measuring channel.

The measuring assembly can comprise a component, in which each of the at least one measuring channel is formed. The component can be formed in one piece. The component is formed, for example, of ceramic material, in order to ensure a high abrasion resistance. Alternatively or additionally, the flow straightener can be made of ceramic material. The measuring channels can be incorporated into the component (e.g. by means of milling, punching or sawing). It is also conceivable that the component is formed with the internal measuring channels. The component can be essentially cylindrical and can extend along a flow-through direction of at least one of the measuring channels. The component can have recesses, which run radially and which are spaced apart from one another in the flow-through direction, for receiving the pressure sensors of the pressure sensor assembly. Two or more of the recesses can be provided for each measuring channel. The recesses can be formed as through hole all the way into the respective measuring channel. In this case, the sensor surface can be part of the pressure sensor, which is inserted into the recess.

The component can be encased by a tubular housing, which can be referred to as housing tube. The component or/and the housing tube can be formed so that a virtual encasement of the component or/and housing tube is curved concavely in the flow-through direction. In other words, the component or/and the housing tube can be formed to be bulgy. The housing tube can comprise cooling fins, in order to passively control the temperature of the material to be conveyed in the measuring channel. A heating or/and cooling device can be provided, which is configured to ensure a defined temperature of the housing, of the component or/and of the material to be conveyed in the measuring channel.

The flow-through directions of the measuring channels can run parallel to one another. Alternatively or additionally, it can be provided that width directions of the cross sections of the measuring channels run obliquely to one another. It can in particular be provided that the at least one straight section of the cross section of each measuring channel, based on a common axis (e.g., a longitudinal axis of the component), is aligned radially outwards. External (e.g., width) sides of the cross sections can be arranged tangentially, based on a virtual circle, or can have the same distance from a reference point (e.g., a point on the longitudinal axis of the component), respectively.

According to a second aspect, a pump system is provided. The pump system comprises the positive displacement pump according to the first aspect and a control unit. The control unit is configured to determine a viscosity of the conveyed material to be conveyed or/and a conveying speed (e.g. a provided volume flow) of the positive displacement pump, based on the pressures detected by the pressure sensor assembly.

The control unit can be designed to classify the viscosity as being visco-plastic, shear-thinning, shear-thickening, Newtonian or Binghamian. The control unit can be designed to determine, based on the pressures detected by the pressure sensor assembly, whether the material to be conveyed is a material with or without a viscosity-dependent shear rate or/and a material with or without flow limit. For this purpose, viscosity values can be determined for several of the measuring channels, which can also be referred to as viscosity multi-point measurement.

The control unit can be configured to determine the conveying speed of the positive displacement pump based on a pump speed of the positive displacement pump or/and a pump control signal for the positive displacement pump, and in particular based on an already known pump characteristic curve of the positive displacement pump, and to determine the viscosity of the conveyed material to be conveyed based on the conveying speed determined in this way and the pressures detected by the pressure sensor assembly. This viscosity can also be determined as a function of at least one parameter (e.g. shear rate or/and temperature).

The control unit is configured in particular for carrying out one or several of the following steps: outputting a value of the determined conveying speed or/and of a value of the determined viscosity; detecting a wear of the positive displacement pump on the basis of the determined conveying speed or/and viscosity; detecting a slip of the positive displacement pump on the basis of the determined conveying speed or/and viscosity; controlling the positive displacement pump on the basis of the determined conveying speed or/and viscosity; controlling a viscosity adaptation device on the basis of the determined conveying speed or/and viscosity, in order to adapt the viscosity of the conveyed material to be conveyed; controlling a processing plant, which processes the conveyed material to be conveyed, on the basis of the determined conveying speed or/and viscosity.

### BRIEF DESCRIPTION OF THE DRAWINGS

Embodiments of the invention will be described in more detail below with reference to the figures, wherein:

FIG. 1 shows a schematic illustration of a pump system;

FIG. 2 shows a perspective illustration of a measuring assembly;

FIG. 3 shows a longitudinal section through a measuring assembly;

FIG. 4 shows a cross section of a measuring channel;

FIG. 5 shows a cross section through a component with several measuring channels;

FIG. 6 shows a first exemplary fluidic interconnection; and

FIG. 7 shows a second exemplary fluidic interconnection.

### DETAILED DESCRIPTION

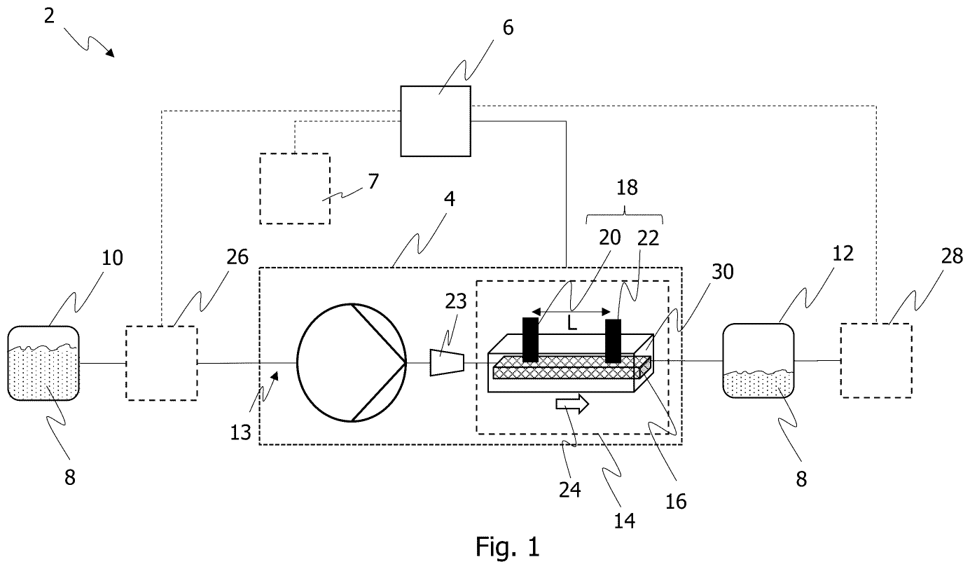

FIG. 1 shows a schematic illustration of a pump system 2. The pump system 2 comprises a positive displacement pump 4 and a control unit 6, which is communicatively connected to the positive displacement pump 4. The control unit 6 can be mechanically fastened to the pump 4 or can be provided separately from the pump 4.

The positive displacement pump 4 can be an eccentric screw pump, whereby other types of positive displacement pumps are also possible. The positive displacement pump 4 is configured for conveying free-flowing filling material 8, such as in particular varnish, oil or suspensions (e.g., waste water) from a filling material storage 10 into a filling material receptacle 12.

The positive displacement pump 4 comprises a measuring assembly 14. In the shown example, the measuring assembly 14 is located at a region of the pump 4 lying downstream. Alternatively, the measuring assembly 14 could also be arranged at the region lying upstream, which is suggested by the reference numeral 13. In any case, the measuring assembly 14 comprises at least one measuring channel 16 as well as a pressure sensor assembly 18 with pressure sensors 20, 22. In the shown example, two pressure sensors are provided for a measuring channel 16, but it is also conceivable to provide three, four or even more pressure sensors for the measuring channel 16.

As least a portion of the material to be conveyed 8, which is conveyed by the pump 4, can flow through the measuring channel 16. The pressure sensors 20, 22 are spaced apart from one another in the flow-through direction 24 of the measuring channel 16 (e.g., distance L from sensor center to sensor center) and can detect a pressure prevailing at the respective positions in the interior of the measuring channel 16. This pressure can either be detected as absolute pressure or as differential pressure (e.g. based on a predetermined reference pressure, in particular an atmospheric pressure in the surrounding area of the pump 4).

The measuring assembly 14 can comprise further sensors, in particular a temperature sensor for detecting a temperature of the material to be conveyed, which is conveyed by the pump 4. It is conceivable that the measuring assembly 14 has one or several temperature sensors for each measuring channel 16 for detecting a temperature of the material to be conveyed, which is transported through the corresponding measuring channel 16. Temperature measurements of these temperature sensors can be used, e.g., to detect a shear heating. A heating or/and cooling device 7 can be provided, which is or are configured to ensure a defined temperature of a housing of the pump system 2, of a component of the pump system 2 or/and of the material to be conveyed in the measuring channel 16.

The measuring assembly can also have a flow straightener 23, which is arranged upstream of the at least one measuring channel 16 and which serves the purpose of effecting a desired (e.g., laminar) flow profile of the material to be conveyed in the measuring channel 16. In the simplest case, the flow straightener forms a funnel-shaped inlet of the measuring channel 16 and can in particular be made of abrasion-resistant material, such as, e.g., ceramic.

An optional viscosity adaptation device 26 is further suggested in FIG. 1. It can adapt the viscosity of the material to be conveyed, for example by adding diluents or thickening agents, by controlling the temperature of the material to be conveyed or/and by adapting a particle size distribution in the material to be conveyed (e.g., by grinding particles contained in the material to be conveyed). An optional processing plant 28 is moreover suggested, which is configured to use the material to be conveyed 8, which is conveyed by the pump 4, in a production or/and processing process. This can be, e.g., a coating plant for applying varnish, in particular for producing multi-layer battery cell.

The control device 6 is designed to determine a viscosity of the conveyed material to be conveyed or/and a conveying speed of the positive displacement pump based on the pressures detected by the pressure sensor assembly. The viscosity can be determined based on the pressure difference of the pressures detected by the pressure sensors 20, 22 while flowing through the measuring channel 16 as well as based on the volume flow through the measuring channel 16 and based on the known geometry of the measuring channel. In the shown example, the entire volume flow of the material to be conveyed, which is conveyed by the pump 4, is guided through the measuring channel 16. The volume flow through the measuring channel 16 thus results directly from the conveying speed of the positive displacement pump. The control unit 6 can be designed to determine this conveying speed, based on a pump speed of the positive displacement pump 4 or/and a pump control signal for the positive displacement pump 4, and in particular based on an already known pump characteristic curve of the positive displacement pump 4. In particular under the assumption that the material to be conveyed is not compressible, it is not necessary to provide a separate volume flow measurement for determining the viscosity.

Based on the determined conveying speed or/and the determined viscosity, the control unit 6 can output a corresponding value (e.g., to a screen or a data processing device). The determined conveying speed or/and viscosity can also be further processed by the control unit 6.

If it can be assumed, e.g., that the viscosity is constant, but the pressure values detected by the sensors 20, 22 change over a certain time period, a conclusion can be drawn to a decreasing conveying speed of the conveying pump. If the pump 4 was controlled with the same control signal (e.g. pump frequency) in this time period, the control unit 6 can draw the conclusion that wear of the pump at hand 4 is present or/and the slip of the pump 4 increased. The control unit 6 can then output a warning or readjust the pump 4, until the pressure values fall within a desired range again, which corresponds to a desired volume flow with the known constant viscosity.

If it can be assumed, in contrast, that the determined conveying speed of the pump 4 is constant, but the pressure values detected by the sensors 20, 22 change over a certain time period, a conclusion can be drawn to a change of the viscosity of the material to be conveyed 8. In particular the temperature of the material to be conveyed 8 can be considered hereby, for example in order to determine if the change is only temperature-related or has other causes. The control unit 6 can then output a warning or control the viscosity adaptation device 26, in order to adapt the viscosity in the direction of a desired value. Alternatively or additionally, the control unit 6 can inform the processing plant 28 of the viscosity change, so that the manufacturing process is adapted accordingly.

The pressure values can be analyzed temporally in order to detect an undesired pulsation of the pump 4 in particular after the latter is turned on. The control unit 6 can then readjust the pump 4 accordingly, in order to minimize such a pulsation. In the case of an eccentric screw pump, the controlling or readjusting of the pump 4 can comprise, e.g., an adapting of a position of a stator of the pump 4.

A pressure drop occurs in flow-through direction of the at least one measuring channel 16 during the operation of the pump 4, thus when the measuring channel 16 is flown through. The pressure drop can in particular take place linearly along the flow-through direction. The two pressure sensors 20, 22 thus detect pressures of different sizes, which are created by the material to be conveyed 8 in the measuring channel 16. In particular the viscosity of the material to be conveyed 8 can be determined from this pressure difference. The following applies:

$$η = σ / \dot{y} \qquad ( formula 1 )$$

Whereby η specifies the viscosity as a function of shear stress σ and shear rate \dot{y}. Knowing a channel geometry factor K of the measuring channel 16, the viscosity η follows as a function of the pressure difference Δp between the two pressure values detected by the pressure sensors 20, 22 and the volume flow \dot{V} flowing through the channel 16:

$$η = Δ p / \dot{V} * K \qquad ( formula 2 )$$

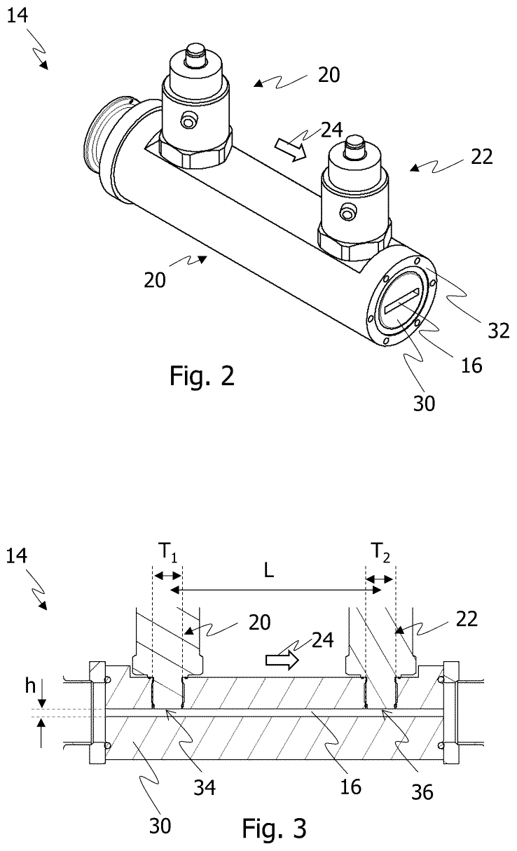

FIG. 2 shows a perspective illustration of an exemplary measuring assembly 14. In this example, the measuring assembly 14 comprises an essentially cylindrical component 30, in which the measuring channel 16 is formed. Both the measuring channel 16 and the component 30 extend along the flow-through direction 24. In FIG. 2, the component 30 is embedded into a housing tube 32, which is not necessarily the case, however.

FIG. 3 shows a longitudinal section along the flow-through direction 24 through an exemplary measuring assembly 14. No housing tube 32 is present in this example, the component 30 is thus not encased. It can be seen in FIG. 3 that each sensor has a sensor surface 34, 36, which laterally delimits the measuring channel 16. These sensor surfaces 34, 36 are spaced apart from one another in the flow-through direction 24 and each extend only over a portion T₁ or T₂, respectively, of the length of the measuring channel 16 in the flow-through direction 24. In the shown example, the sensor surfaces 34, 36 are comparatively large compared to the height h of the measuring channel 16 (T₁>h, T₂>h). A high shear rate can thus be provided in the measuring channel 16. It is also conceivable to dimension the measuring channel 16 differently (T₁=h or T₁<h; or/and T₂=h or T₂<h), for example if a lower shear rate is desired. The centers of the respective sensor surfaces 34, 36 are offset at a distance L in the flow-through direction 24.

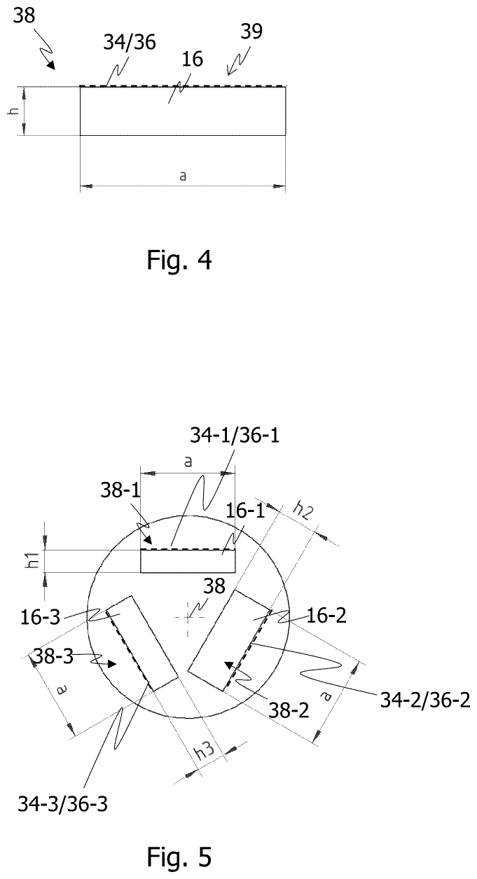

The at least one measuring channel 16 has a non-circular cross section 38, in particular a cross section with one or several straight sections 39. The sensor surfaces 34, 36 can form one of these straight sections hereby. FIG. 4 shows an example for such a non-circular cross section 38 of the at least one measuring channel 16. In this example, the cross section 38 is rectangular and has a height h, which is smaller than the width a. In the width direction of the cross section 38 of the measuring channel 16, the flat (e.g., likewise rectangular or circular) sensor surfaces 34 and 36 run over the entire width thereof and form the top side thereof.

In the case of the cross section 38, the following applies for the channel geometry factor K of the measuring channel 16:

$$K = ( a * h \hat{} 3 ) / ( 12 * L * ( 1 + h / a ) ) \qquad ( formula 3 )$$

In this case, the viscosity of the material to be conveyed 8, based on the pressure difference Δp and the volume flow \dot{V}, results as:

$$η = ( Δ p / \dot{V} ) * ( a * h \hat{} 3 ) / ( 12 * L * ( 1 + h / a ) ) \qquad ( formula 4 )$$

In the case of known volume flow, the viscosity can thus be calculated on the basis of the detected pressures, in the case of known viscosity, the volume flow can be calculated on the basis of the detected pressures. This can also be the case in the case of other channel geometries, whereby the channel geometry factor K may then deviate from formula 3.

The at least one measuring channel 16 can comprise several measuring channels 16-1, 16-2, . . . , 16-n. In other words, the measuring assembly 14 can comprise several measuring channels 16, which are formed accordingly. The measuring channels can differ from one another in particular in their cross section 38-1, 38-2, . . . , 38-2n. Respective values of the pressure difference Δp can thus be determined for different channel cross sections. A corresponding viscosity value of the material to be conveyed can be determined therefrom for each of the measuring channels. By comparing these viscosity values, the control unit 6 can draw a conclusion to the viscosity, which is a function of the shear rate, of the material to be convyed and can in particular determine if the material to be conveyed is shear-thinning or shear-thickening.

FIG. 5 shows an example for an arrangement of several measuring channels 16-a, 16-2, 16-3, all of which are formed in the same component 30, the flow-through directions of which run parallel. The measuring channels 16-1, 16-2, 16-3 hereby each have a rectangular cross section 38-1, 38-2, 38-3. Even though the cross sections have the same width a, they have different heights h1, h2, h3.

For each measuring channel 16-1, 16-2, 16-3, corresponding pressure sensors are provided with sensor surfaces 34-1, 34-2, 34-3 and 36-1, 36-2, 36-3. The sensor surfaces also form the respective top side of the respective measuring channel here. The sensor surfaces are thereby aligned radially outwards, based on a longitudinal axis 38 of the component 30, which runs in the flow-through direction. The pressure sensors can thus be fastened to the component 30 from different directions, in order to measure the pressures in the differently dimensioned channels.

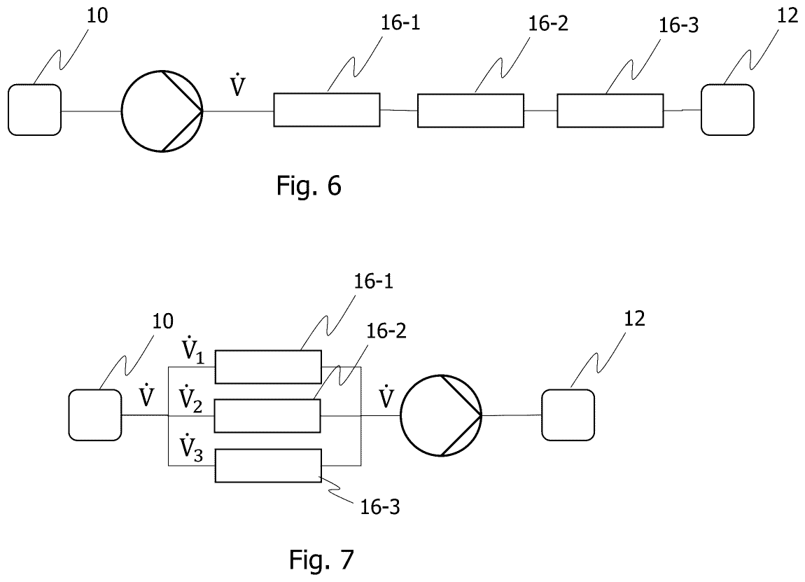

The measuring channels 16-1, 16-2, 16-3 can be fluidically connected in series or in parallel to one another. A corresponding series connection is illustrated schematically in FIG. 6, FIG. 7 illustrates a parallel connection. In the series connection, the same volume flow V can flow through each measuring channel 16-1, 16-2, 16-3. In the parallel connection, the volume flow \dot{V}, in contrast, splits up into three partial flows \dot{V}₁, \dot{V}₂, \dot{V}₃, each of which flows through a different one of the measuring channels 16-1, 16-2, 16-3.

It goes without saying that only one, only two, four or more measuring channels 16 can be provided instead of three measuring channels. They can be connected in parallel in groups or/and can be connected in series in groups. One or more of the measuring channels 16 can be arranged upstream of, and one or more of the measuring channels 16 can be arranged downstream from the eccentric screw pump. It is also conceivable that a further pump (e.g., with larger conveying capacity) is used parallel to the pump 4, in order to convey material to be conveyed from the filling material storage 10 into the filling material receptacle 12. The measuring assembly 14 can be arranged outside of a pump housing of the positive displacement pump 4, for example in a line system, which is fluidically connected to the positive displacement pump 4. Further advantages and modifications can result for the person of skill in the art from the disclosure at hand.

1. A positive displacement pump for conveying material to be conveyed, comprising a measuring assembly with at least one measuring channel, through which at least a portion of the material to be conveyed, which is conveyed by the pump, can flow, wherein the at least one measuring channel has a non-circular cross section and the measuring assembly has a pressure sensor assembly for detecting pressures, which act at positions, which are spaced apart in the flow-through direction of the at least one measuring channel, when the at least one portion of the material to be conveyed, which is conveyed by the pump, flows through the at least one measuring channel.

2. The positive displacement pump according to claim 1, wherein the cross section of the at least one measuring channel comprises at least one straight section.

3. The positive displacement pump according to claim 2, wherein the cross section is polygonal.

4. The positive displacement pump according to claim 2, wherein the cross section is rectangular and each of the four sides of the rectangular cross section corresponds to one of the at least one straight section.

5. The positive displacement pump according to claim 2, wherein the pressure sensor assembly is configured to detect a pressure acting from an interior of the at least one measuring channel on a sensor surface, wherein the sensor surface forms one of the at least one straight section of the cross section and extends over a portion of the length of the at least one measuring channel in the flow-through direction thereof.

6. The positive displacement pump according to claim 5, wherein the cross section has a height, which is smaller than the width thereof and wherein the sensor surface runs in the width direction of the cross section.

7. The positive displacement pump according to claim 1, wherein the at least one measuring channel comprises several measuring channels, through which at least a portion of the material to be conveyed, which is conveyed by the pump, can flow in each case, wherein the measuring channels differ in their cross sections.

8. The positive displacement pump according to claim 7, wherein the measuring channels are fluidically connected in parallel and the measuring assembly comprises a component, in which each of the measuring channels is formed.

9. The positive displacement pump according to claim 7, wherein the flow-through directions of the measuring channels run parallel to one another or/and width directions of the cross sections of the measuring channels run obliquely to one another.

10. A pump system, comprising a positive displacement pump for conveying material to be conveyed, having a measuring assembly with at least one measuring channel, through which at least a portion of the material to be conveyed, which is conveyed by the pump, can flow, wherein the at least one measuring channel has a non-circular cross section and the measuring assembly has a pressure sensor assembly for detecting pressures, which act at positions, which are spaced apart in the flow-through direction of the at least one measuring channel, when the at least one portion of the material to be conveyed, which is conveyed by the pump, flows through the at least one measuring channel; and
a control unit, which is configured to determine a viscosity of the conveyed material to be conveyed or/and a conveying speed of the positive displacement pump, based on the pressures detected by the pressure sensor assembly.

11. The pump system according to claim 10, wherein the control unit is configured to determine the conveying speed of the positive displacement pump based on a pump speed of the positive displacement pump or/and a pump control signal for the positive displacement pump, and in particular based on an already known pump characteristic curve of the positive displacement pump, and to determine the viscosity of the conveyed material to be conveyed based on the conveying speed determined in this way and the pressures detected by the pressure sensor assembly.

12. The pump system according to claim 10, wherein the control unit is further configured for carrying out one or several of the following steps:
outputting a value of the determined conveying speed or/and of a value of the determined viscosity;
detecting a wear of the positive displacement pump on the basis of the determined conveying speed or/and viscosity;
detecting a slip of the positive displacement pump on the basis of the determined conveying speed or/and viscosity;
controlling the positive displacement pump on the basis of the determined conveying speed or/and viscosity;
controlling a viscosity adaptation device on the basis of the determined conveying speed or/and viscosity, in order to adapt the viscosity of the conveyed material to be conveyed;
controlling a processing plant, which processes the conveyed material to be conveyed, on the basis of the determined conveying speed or/and viscosity.

13. The positive displacement pump according to claim 3, wherein the cross section is rectangular and each of the four sides of the rectangular cross section corresponds to one of the at least one straight section.

14. The positive displacement pump according to claim 3, wherein the pressure sensor assembly is configured to detect a pressure acting from an interior of the at least one measuring channel on a sensor surface, wherein the sensor surface forms one of the at least one straight section of the cross section and extends over a portion of the length of the at least one measuring channel in the flow-through direction thereof.

15. The positive displacement pump according to claim 2, wherein the at least one measuring channel comprises several measuring channels, through which at least a portion of the material to be conveyed, which is conveyed by the pump, can flow in each case, wherein the measuring channels differ in their cross sections.

16. The positive displacement pump according to claim 8, wherein the flow-through directions of the measuring channels run parallel to one another or/and width directions of the cross sections of the measuring channels run obliquely to one another.

17. The pump system according to claim 11, wherein the control unit is further configured for carrying out one or several of the following steps:
outputting a value of the determined conveying speed or/and of a value of the determined viscosity;
detecting a wear of the positive displacement pump on the basis of the determined conveying speed or/and viscosity;
detecting a slip of the positive displacement pump on the basis of the determined conveying speed or/and viscosity;
controlling the positive displacement pump on the basis of the determined conveying speed or/and viscosity;
controlling a viscosity adaptation device on the basis of the determined conveying speed or/and viscosity, in order to adapt the viscosity of the conveyed material to be conveyed;
controlling a processing plant, which processes the conveyed material to be conveyed, on the basis of the determined conveying speed or/and viscosity.
